(19) United States
(12) Patent Application Publication
(10) Pub. No.: US 2011/0284453 A1
(43) Pub. Date: Nov. 24, 2011

(54) OIL FILTER FOR AUTOMATIC TRANSMISSION

(75) Inventors: Takazumi TOYOSHIMA, Hamamatsu-shi (JP); Masanori GOTO, Hamamatsu-shi (JP); Hirokazu SUZUKI, Hamamatsu-shi (JP)

(73) Assignee: ROKI CO., LTD., Hamamatsu-shi (JP)

(21) Appl. No.: 13/084,767

(22) Filed: Apr. 12, 2011

(30) Foreign Application Priority Data
May 19, 2010 (JP) 2010-115236

(51) Int. Cl. B01D 35/02

(52) U.S. Cl. 210/435

(57) ABSTRACT

An oil filter for an automatic transmission includes a housing which is composed of a case having an opened end portion and a cover covering the opened end of the case, the case being formed with a flow-in port and the cover being formed with a flow-out port, a filter element dividing an interior of the housing into a dust side section positioned on the flow-in port side and a clean side section positioned in the flow-out port side, the filter element including a first filter to which a flow-in hole continuous to the flow-in port is formed and a second filter opposing to the first filter, and a flow passage ensuring unit disposed between the first filter and the second filter for defining a predetermined gap therebetween.

### BACKGROUND OF THE INVENTION

1. Field of the Invention

The present invention relates to an oil filter for an automatic transmission.

2. Related Art

There is conventionally known an oil filter for an automatic transmission for filtrating oil utilized for an automatic transmission. Such automatic transmission is provided with a housing including a case having an open end and a cover adapted to open or close the case, for example, as shown in FIG. 8. The oil filter is also provided with a filter element or member for sectioning the interior of the housing into a dust side section and a clean side section for filtrating a fluid passing through the interior of the housing.

Other than a case where a flat-shaped filter element formed of a non-woven fabric is assembled, in order to increase a filtrating area and/or reducing pressure loss, as such filter element, there are known various ones having structures in which a flat-shaped filter element is folded back so as to make pleating working or a flat-shaped filter element is bent into two sections which are then accommodated in the housing.

Such prior art technologies are shown, for example, in the following documents.

Patent Document 1: Japanese Patent Application Laid-open Publication No. 2004-176809

Patent Document 2: Japanese Patent Application Laid-open Publication No. 2006-43635

The Patent Document 1 discloses an oil filter for an automatic transmission or gear box. This oil filter is for an automatic transmission in which a hole communicating with a dust side is formed to a filter element and an edge portion of this hole is joined to an oil flow-in port formed to a case by means of joining member, wherein the joining member includes a tubular portion to be inserted into a passage of the oil flow-in port from the interior of the case and a pressing member provided to one end of the tubular portion so as to sandwich the hole edge portion of the filter element together with the case, and the tubular portion is engaged with the case by a snap-engaging member, thereby applying pressure to the hole edge portion of the filter element by the pressing member and the case.

Such oil filter for the automatic transmission as disclosed in the Patent Document 1 does not require any device or member such as specific jig for assembling the joining member, and the filter element can thus be easily accommodated, so that the filter element can be prevented from being broken at calking (calked) portion or welding (welded) portion and also prevented from shifting in locating position.

On the other hand, the Patent Document 2 discloses a filtrating device includes a housing having a case having an open end and a cover for tightly closing the case, and a filter element is folded back and accommodated into the housing. The case or cover is formed with an intake port for taking fluid into the filtrating device. The filter element is formed with an opening, and a folding lines having foldable tick are formed in a single axial direction with an interval from each other. The filter element is folded sterically with the folding lines so as to form a gap between a surface to which the opening is formed and a surface opposing the aforementioned surface, and in such folded state, one end of the above-mentioned single axial direction is formed as an end surface composed of a portion between the folded lines. Then, the filter element has a structure, in the folded state, in which the opening is coincident in position with the take-in port, and three sides, except one side in which the end surface is positioned, are sandwiched by the case and the cover to be thereby accommodated in the housing.

The filtrating device, having the above-mentioned structure, disclosed in the Patent Document 2 becomes free from pressure loss and clogging of the filter element, and in addition, can be designed with high degree of freedom at a low cost and with short time period, thus accommodating the filter element into the housing in a stable state.

According to the conventional oil filter for the automatic transmission of the structure described above, as shown in FIG. 8, in a structure where the position of mating surfaces 151 and 152 of a cover 110 and a case 120 is higher, in level, than the location of a flow-in port 121 of a fluid such as oil by a distance L, since a first filter 131 is attached to the flow-in port 121 by tucking the first filter 131 into an edge portion of the flow-in port 121 by a joining member 140, the oil filter can be assembled in a state of being pulled in a direction separating from a second filter 132 opposing to the first filter without urging the second filter in a direction separating from the first direction by any means, and hence, it becomes possible to forcibly form a gap between the first and second filters 131 and 132.

On the other hand, as shown in FIG. 9, in a structure where the position of the mating surfaces 151 and 152 of the cover 110 and the case 120 is, in level, equal to or lower than the location of the flow-in port 121, it is impossible to form a desired gap between the first and second filters 131 and 132, and hence, it becomes difficult to effectively utilize the filtrating area, thus providing disadvantage. Further, the above-mentioned structure, in which the position of the mating surfaces 151 and 152 of the cover 110 and the case 120 is, in level, equal to or lower than the location of the flow-in port 121, may include a case, for example, in which a flowing passage 122 for introducing fluid in a direction perpendicular to the flow-in port is formed to the lower surface of the case, and hence, the flow-in port 121 is formed higher by the height of the flowing passage 122 in comparison with the case shown in FIG. 8.

### SUMMARY OF THE INVENTION

The present invention was conceived in consideration of the circumstances of the prior art mentioned above and an object thereof is to provide an oil filter for an automatic transmission capable of forming a gap between a first filter and a second filter with a simple structure and not causing increasing in pressure loss and reduction in filtrating area regardless of positions of a flow-in port and mating surfaces between a case and a cover of a housing in which the filter element is accommodated.

The above and other objects can be achieved according to the present invention by providing an oil filter for an automatic transmission, including: a housing having a case having an opened end portion and a cover covering the opened end of the case, the case being formed with a flow-in port and the cover being formed with a flow-out port; a filter element dividing an interior of the housing into a dust side section positioned on the flow-in port side and a clean side section positioned in the flow-out port side, the filter element including a first filter to which a flow-in hole continuous to the flow-in port is formed and a second filter opposing to the first filter; and a flow passage ensuring unit (structure) disposed between the first filter and the second filter for defining a predetermined gap therebetween.

In an embodiment of the present invention of the aspect described above, the following preferable examples may be provided for achieving the object.

The filter element may be formed of a sheet-shaped material, and the first and second filters are formed by folding back the sheet-shaped filter element.

It may be desired that the flow-in hole formed to the first filter is joined to the flow-in port by a joining member, the joining member including an insertion portion to be inserted into an edge portion of the flow-in port and a flanged portion clamping the edge portion of the flow-in hole and the flow-in port, and the flow passage ensuring unit is formed to the flanged portion.

In the above example, the flow passage ensuring unit may be composed of a rib member standing upward from the flanged portion.

The rib member constituting the flow passage ensuring unit may include a plurality of rib pieces which are arranged along the edge portion of the flow-in port at a predetermined interval from each other.

The rib member may be formed so as to extend in a radial direction from the flow-in port.

It may be further desired that the case is disposed so as to extent in parallel with the filter element and is formed with a flow passage continuous to the flow-in port.

It is to be noted that the present embodiment of the present invention does not include all the necessary features of the present invention, and sub-combination of such features may constitute a preferred embodiment of the present invention.

According to the oil filter for the automatic transmission of the present embodiment of the characters and structures mentioned above, since the flow passage ensuring structure is formed between the first and second filters, a gap can be formed between the first and second filters, and thereby, preventing the first and second filters from adhering to each other, which can prevent the increasing in the pressure loss and the reduction of the filtrating area, thus designing the position of the flow-in port, and hence, the oil filter for the automatic transmission having high degree of freedom can be provided.

Furthermore, according to the oil filter of the present invention, since the first and second filters are formed by folding back the filter element formed into sheet shape, the filtrating area can be increased, and when accommodating into the housing, the filter element can be surely assembled therein without causing any defect such as position-shifting or like.

Still furthermore, according to the oil filter for the automatic transmission of the present invention, the flow passage ensuring unit (structure) is formed of the joining member for mounting the first filter to the case, there is no need for increasing the number of parts to be assembled, and a gap can be easily defined between the first and second filters. Moreover, the position of the flow-in port can be designed without causing the pressure loss and the reduction of the filtrating area due to the adhesion between the first and second filters, and hence, the oil filter for the automatic transmission having high degree of freedom can be provided.

Still furthermore, according to the oil filter for the automatic transmission of the present invention, since the flow passage ensuring structure may be formed by a rib member standing upward from the flanged portion of the joining member, the flow passage ensuring structure can be easily and cheaply formed.

Still furthermore, according to the oil filter for the automatic transmission of the present invention, since the flow passage ensuring structure may be formed along the edge portion of the flow-in port with a predetermined interval from each other, the adhesion of the first and second filters can be effectively prevented.

Still furthermore, according to the oil filter for the automatic transmission of the present invention, since the flow passage ensuring structure may be formed of a rib member extending radially from the flow-in port, the first and second filters can be prevented from adhering to each other regardless of the shape of the housing.

Still furthermore, according to the oil filter for the automatic transmission of the present invention, the flow passage may be formed to the case so as to extend substantially in parallel with the filter element and continuous to the flow-in port, the direction along which the oil is introduced is not limited to the direction perpendicular to the flow-in port, the oil filter for the automatic transmission can be easily connected even if the oil flow-in port is oriented in any direction.

The nature and further characteristic features of the present invention will be made more clearer from the following descriptions with reference to the accompanying drawings.

### BRIEF DESCRIPTION OF THE DRAWINGS

In the accompanying drawings:

FIG. 1 is an illustrated plan view showing a schematic structure of an oil filter for an automatic transmission according to one embodiment of the present invention;

FIG. 2 is a sectional view taken along the line II-II in FIG. 1;

FIG. 3 is a sectional view taken at a mating surface of a case for explaining a structure of the oil filter for the automatic transmission shown in FIG. 1;

FIG. 4 is a sectional view taken at a mating surface of a case for explaining a structure of a first modified example of the oil filter for the automatic transmission according to the present embodiment;

FIG. 5 is a sectional view taken at a mating surface of a case for explaining a structure of a second modified example of the oil filter for the automatic transmission according to the present embodiment;

FIG. 6 is a sectional view taken at a mating surface of a case for explaining a structure of a third modified example of the oil filter for the automatic transmission according to the present embodiment;

FIG. 7 is a sectional view taken at a mating surface of a case for explaining a structure of a fourth modified example of the oil filter for the automatic transmission according to the present embodiment;

FIG. 8 is a sectional view for explaining a structure of a conventional oil filter for an automatic transmission taken along the same line II-II in FIG. 2; and

FIG. 9 is a sectional view for explaining a structure of another conventional oil filter for an automatic transmission taken along the same line II-II in FIG. 2.

### DESCRIPTION OF THE PREFERRED EMBODIMENT

Hereunder, preferred embodiments of the present invention will be described with reference to the accompanying drawings. It is further to be noted that the described embodiments do not limit the invention recited in respective claims and all the combination of subject features explained in the embodiments are not essential for the solution of the present invention. Furthermore, it is also to be noted that terms such as “upper”, “lower”, “right”, “left” and like terms showing directions are used herein in the illustrated state or in an actually installed state of an oil filter.

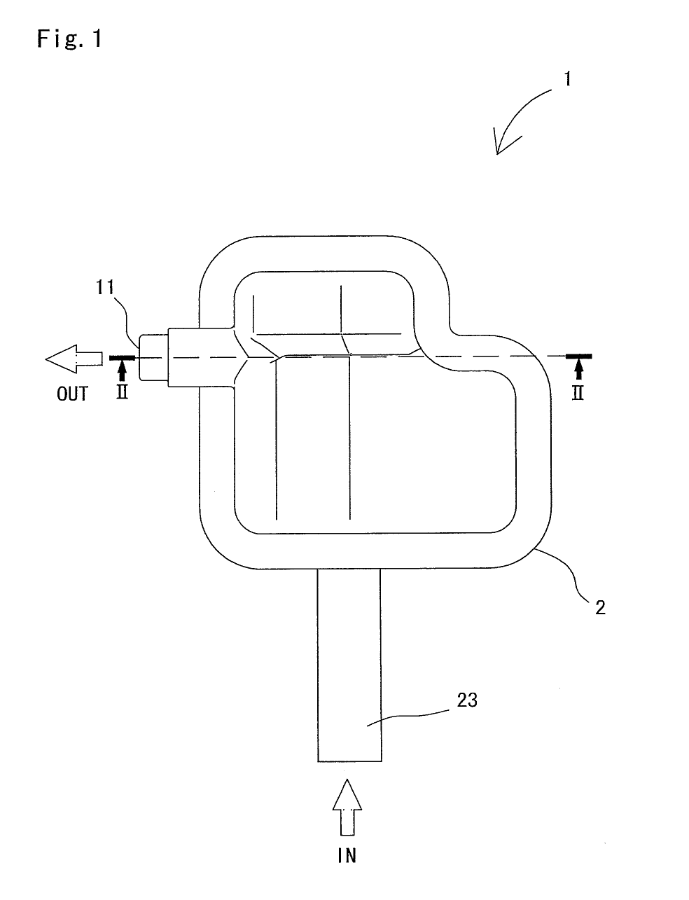

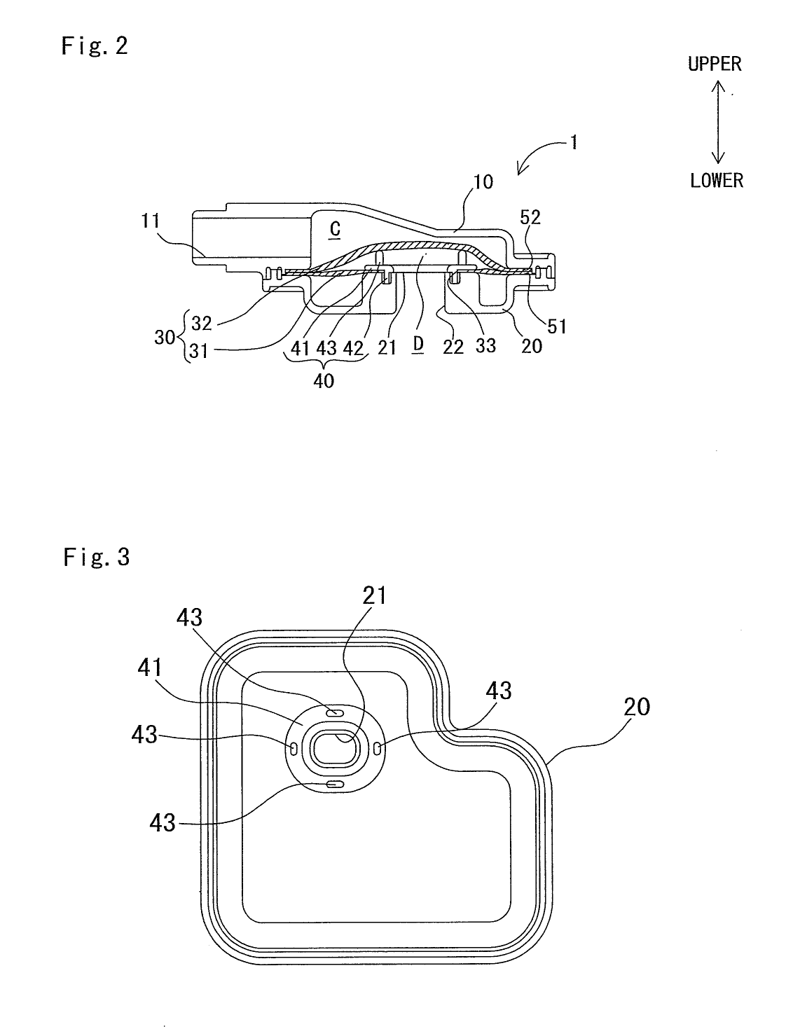

With reference to FIG. 1, reference numeral 1 denotes an oil filter for an automatic transmission according to one embodiment of the present invention. The oil filter 1 is provided with a flow-in passage 23 communicated with a flow-in port 21 (FIG. 2) so that an oil flowing in the automatic transmission is introduced into the oil filter for the automatic transmission from the flow-in port 21 through the flow-in passage 23. The flow-in passage 23 is formed along a bottom surface of the oil filter 1 and the oil introduced into the oil filter 1 is filtrated therein and then returned to the automatic transmission through a flow-out port 11. According to such structure, the oil is circulated between the automatic transmission and the oil filter 1 for the automatic transmission.

The structure of the oil filter 1 for the automatic transmission according to the present embodiment will be explained with reference to FIG. 2, which is a sectional view taken along the line II-II in FIG. 1.

As shown in FIG. 2, the oil filter 1 for the automatic transmission according to the present embodiment includes a housing 2 provided with a cylindrical bottomed case 20 formed with a flow-in port 21 and having an opened end, and a cover 10 formed with a flow-out port 11 and closing the opened end of the case 20. A flow-in passage holding groove or channel 22 for holding the flow-in passage 23 extending substantially in parallel with a filter element 30, and the flow-in passage 23 is formed to the flow-in passage holding groove 22. The case 20 and the cover 10 may be preferably formed of various synthetic resin materials such as polyamide group resin, polypropylene group resin and the like.

Further, inside the housing 2, the filter element 30 is disposed so as to section the interior of the housing 2 into a dust side section D continuous to the flow-in port 21 and a clean side section C continuous to the flow-out port 11 in a fashion such that the filter element 30 is sandwiched between a mating surface 52 formed to the cover 10 and a mating surface 51 formed to the case 20. According to such structure, the cover 10 and the case 20 can be combined and assembled into the housing 2 by means of welding or fusing such as oscillation welding or ultrasonic welding, or a bolt or clip may be used for screwing or fastening the case and the cover by applying necessary sealing means.

The filter element 30 is formed of a filter material having a sheet shape such as non-woven fabric, and the filter element 30 thus formed includes a first filter 31 and a second filter 32, which are formed by folding back the filter element material into two parts having substantially equal area along a folding line as a boundary line between the first and second filters 31 and 32.

The first filter 31 is formed with the flow-in port 21 and a flow-in hole 33 formed to be continuous to the flow-in port 21 and secured to the case 20 by a joining member 40.

The joining member 40 includes an insertion portion 42 which is inserted into an edge portion of the flaw-in port 21 and a flanged portion 41 clamping the edge portion of the flow-out hole 33 and the flow-in port 21. The flanged portion 41 is formed so as to extend in a direction perpendicular to the axial direction of the insertion portion 42 from one end thereof. Furthermore, the flanged portion 41 is formed with ribs 43 standing upward from the flanged portion 41 as flow passage ensuring means or flow passage ensuring structure.

As shown in FIG. 3, four ribs 43 are provided along the edge portion of the flow-in port 21 at predetermined equal intervals from each other. Since such ribs 43 are interposed between the first filter 31 and the second filter 32, a gap is formed therebetween.

As mentioned above, according to the oil filter 1 for the automatic transmission according to the present embodiment, the oil introduced into the oil filter 1 through the flow-in passage 23 is guided into the gap between the first filter 31 and the second filter 32 through the flow-in hole 33 from the flow-in port 21, in which the oil is filtrated by the first and second filters 31 and 32, and then flows toward the clean side section C and returned to the automatic transmission through the flow-out port 11. That is, the oil flowing inside the oil filter from the direction perpendicular to the drawing paper of FIG. 2 changes in its flowing direction to an upward direction at the flow-in port 21, and then flows toward the clean side section C by removing dust mixed into the oil by the filter element 30. Then, the oil flowing direction changes to the left direction in FIG. 2 and flows out through the flow-out port 11, thus constituting the oil flowing path rote.

As mentioned hereinbefore, according to the oil filter 1 for the automatic transmission of the present embodiment, since the filter element 30 is composed of the first filter 31 and the second filter 32, an area to be filtrated can be easily increased. Furthermore, since the oil is introduced through the flow-in passage 23, the oil can be introduced from an optional direction, and hence, it is not necessary to change the locating position of the flow-in port 21 in accordance with layout of an automatic transmission or other equipments in an engine room of an automobile, thereby easily and cheaply arranging the oil filter in an vehicle body.

Still furthermore, according to the present embodiment, since the location of the ribs 43 prevents adhesion of the first filter 31 to the second filter 32, so that even if the height level of the mating surfaces 51 and 52 of the case 20 and the cover 10 is equal to or lower than, in level, the location position of the flow-in port 21, the mutual adhesion of the first and second filters 31 and 32 can be effectively prevented, thus avoiding the increasing in the pressure loss.

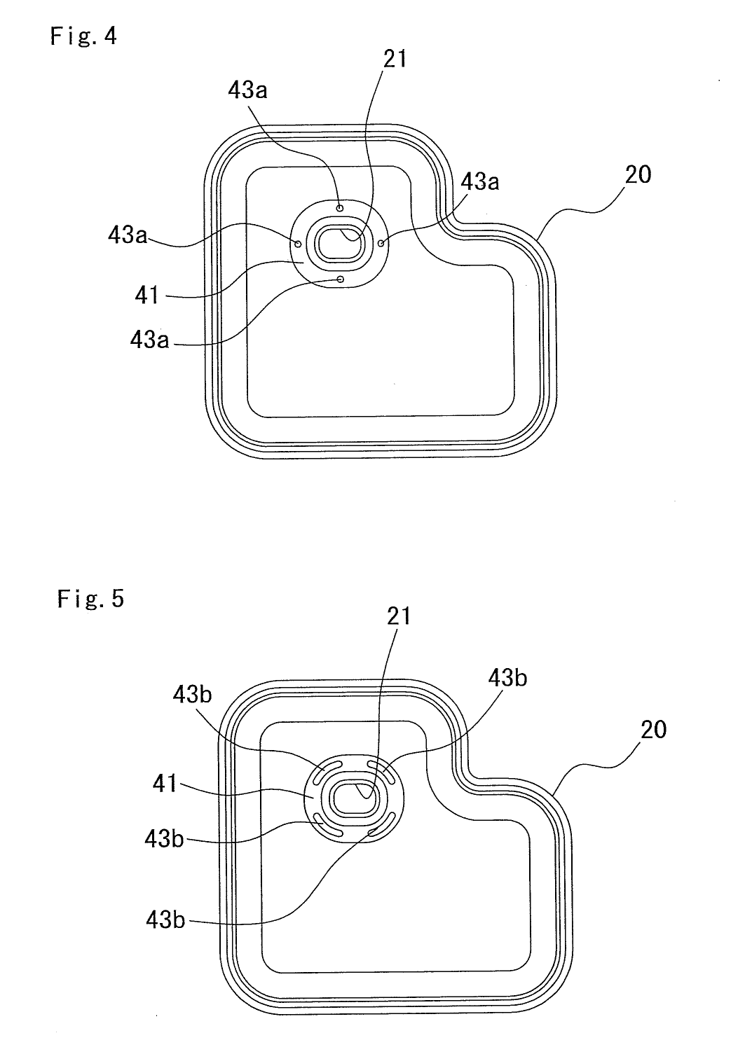

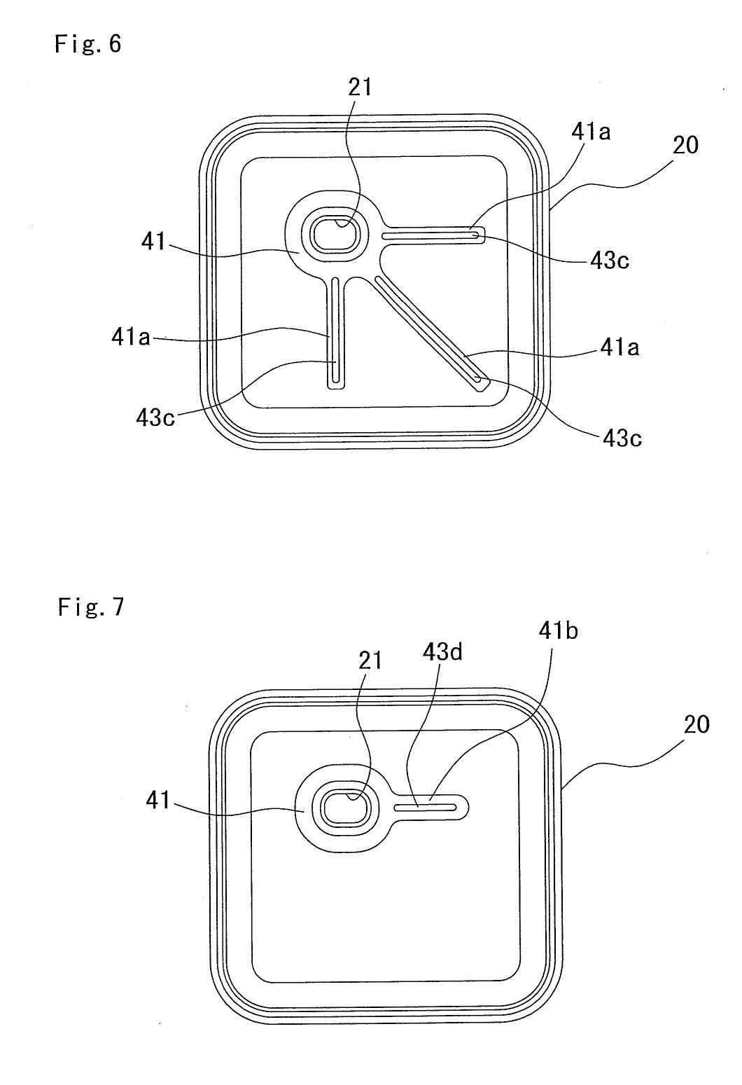

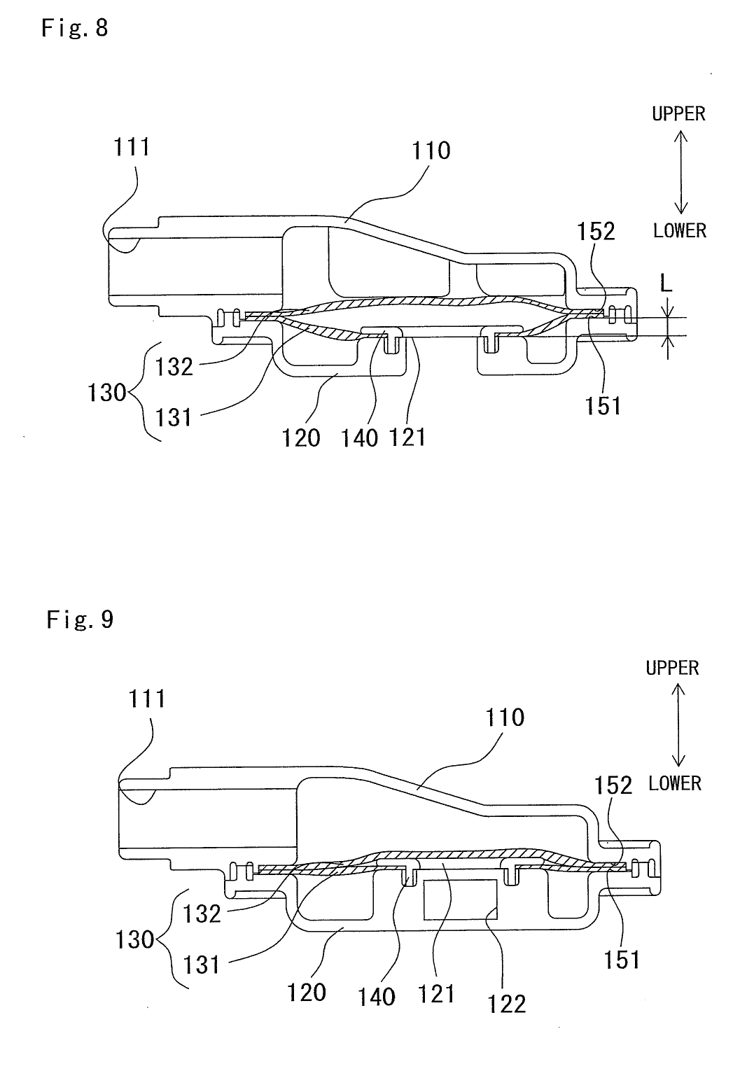

Further, hereinabove, although there is described a preferred embodiment in which the oil filter 1 for the automatic transmission is provided with the ribs 43 as flow passage ensuring means, the flow passage ensuring means is not limited to the described example or structure and other examples or structure may be adopted. For example, as shown in FIG. 4, embosses 43a may be formed alternately, or as shown in FIG. 5, ribs 43b each curved along a corner portion of the flow-in port 21 may be also formed. Furthermore, as shown in FIG. 6, the flanged portion 41 may be formed so as to have portions 43a each extending radially from the flow-in port 21 and ribs 43c may be formed to the extending portions 43a, respectively, and still furthermore, as shown in FIG. 7, the flanged portion 41 may be formed so as to have one extending portion 41b to which a rib 43d is formed.

As mentioned above, the flow passage ensuring means may take various structures or arrangements in accordance with shape of the housing 2 or positions of the mating surfaces 51 and 52.

In addition, although the described embodiment is provided with four ribs 43 at four portions, the number of the ribs is not limited to four and the number thereof may be changed as occasion demands such as shown in FIG. 7, in which one rib 43d is formed. Still furthermore, the height in location level of the rib 43 (43b, 43c, 43d) and the emboss 43a may be optionally changed so as to define a desired gap between the first filter 31 and the second filter 32, and in the case where a plurality of ribs or embosses are formed, it is not necessary to accord with the heights of the respective ribs or embosses, the heights may be changed optionally according to the shape of the housing 2.

As mentioned above, it is to be noted that the present invention is not limited to the described embodiments and many other changes and modifications will be made within technical range or spirits of the appended claims.

What is claimed is:

1. An oil filter for an automatic transmission, comprising:
a housing having a case having an opened end portion and a cover covering the opened end of the case, the case being formed with a flow-in port and the cover being formed with a flow-out port;
a filter element dividing an interior of the housing into a dust side section positioned on the flow-in port side and a clean side section positioned in the flow-out port side, the filter element including a first filter to which a flow-in hole continuous to the flow-in port is formed and a second filter opposing to the first filter; and
a flow passage ensuring unit disposed between the first filter and the second filter for defining a predetermined gap therebetween.

2. The oil filter for an automatic transmission according to claim 1, wherein the filter element is formed of a sheet-shaped material, and the first and second filters are formed by folding back the sheet-shaped filter element.

3. The oil filter for an automatic transmission according to claim 1, wherein the flow-in hole formed to the first filter is joined to the flow-in port by a joining member, the joining member including an insertion portion to be inserted into an edge portion of the flow-in port and a flanged portion clamping the edge portion of the flow-in hole and the flow-in port, and the flow passage ensuring unit is formed to the flanged portion.

4. The oil filter for an automatic transmission according to claim 3, wherein the flow passage ensuring unit is composed of a rib member standing upward from the flanged portion.

5. The oil filter for an automatic transmission according to claim 4, wherein the rib member constituting the flow passage ensuring unit includes a plurality of rib pieces which are arranged along the edge portion of the flow-in port at a predetermined interval from each other.

6. The oil filter for an automatic transmission according to claim 4, wherein the rib member is formed so as to extend in a radial direction from the flow-in port.

7. The oil filter for an automatic transmission according to claim 1, wherein the case is disposed so as to extend in parallel with the filter element and is formed with a flow passage continuous to the flow-in port.
